(19) United States
(12) Patent Application Publication
(10) Pub. No.: US 2022/0194134 A1
(43) Pub. Date: Jun. 23, 2022

(54) PNEUMATIC TIRE

(71) Applicant: Toyo Tire Corporation, Itami-shi (JP)

(72) Inventor: Kota Ono, Itami-shi (JP)

(73) Assignee: Toyo Tire Corporation, Itami-shi (JP)

(21) Appl. No.: 17/547,581

(22) Filed: Dec. 10, 2021

(30) Foreign Application Priority Data
Dec. 21, 2020 (JP) 2020-211098

(51) Int. Cl. B60C 11/03; B60C 11/12

(52) U.S. Cl. CPC B60C 11/0304; B60C 11/0306; B60C 11/1204; B60C 2011/1245; B60C 2011/0346; B60C 2011/1213; B60C 11/1236

(57) ABSTRACT

In a pneumatic tire, a plurality of main grooves include at least one straight main groove for which end edges at a tread surface are respectively parallel to a tire circumferential direction, and at least one zigzag main groove for which end edges at the tread surface are respectively inclined with respect to the tire circumferential direction, the end edges at the tread surface of the at least one zigzag main groove include an inner end edge which is arranged toward an interior in a tire axial direction, and an outer end edge which is arranged toward an exterior in the tire axial direction, and an outwardmost location in the tire axial direction of the inner end edge is arranged toward the interior in the tire axial direction from an inwardmost location in the tire axial direction of the outer end edge.

### CROSS REFERENCE TO RELATED APPLICATIONS

This application claims the benefit of priority of Japanese application no. 2020-211098, filed on Dec. 21, 2020, which is incorporated herein by reference.

### BACKGROUND OF THE INVENTION

### Field of the Invention

The present disclosure relates to a pneumatic tire.

### Description of the Related Art

Conventionally a pneumatic tire might, for example, comprise a plurality of main grooves extending in the tire circumferential direction. The plurality of main grooves might include straight main grooves for which end edges at the tread surface are respectively linear, and irregular main grooves for which end edges at the tread surface are respectively irregular in the tire axial direction (e.g., JP 2011-105169 A).

In addition, end edges at the tread surface of irregular main grooves might include circumferential components which extend in parallel fashion with respect to the tire circumferential direction, and axial components which extend in parallel fashion with respect to the tire axial direction. However, because circumferential components are parallel to the tire circumferential direction, since traction due to circumferential components do not act when the vehicle is going straight ahead on a snowy road surface, it has not been possible to adequately improve performance on snowy road surfaces (e.g., performance with respect to traction on snowy road surfaces).

### SUMMARY OF THE INVENTION

It is therefore an object of the present disclosure to provide a pneumatic tire permitting improvement in performance on snowy road surfaces.

There is provided a pneumatic tire comprises a tread having a tread surface; wherein the tread comprises a plurality of main grooves that extend in a tire circumferential direction;

the plurality of main grooves include at least one straight main groove for which end edges at the tread surface are respectively parallel to the tire circumferential direction, and at least one zigzag main groove for which end edges at the tread surface are respectively inclined with respect to the tire circumferential direction;

the end edges at the tread surface of the at least one zigzag main groove include an inner end edge which is arranged toward an interior in a tire axial direction, and an outer end edge which is arranged toward an exterior in the tire axial direction; and

an outwardmost location in the tire axial direction of the inner end edge is arranged toward the interior in the tire axial direction from an inwardmost location in the tire axial direction of the outer end edge.

### BRIEF DESCRIPTION OF DRAWINGS

FIG. 1 is a drawing for explaining a first inclined direction.

FIG. 2 is a drawing for explaining a second inclined direction.

FIG. 3 is a view of a section, taken along a tire meridional plane, of the principal components in a pneumatic tire associated with an embodiment.

FIG. 4 is a drawing showing the principal components at the tread surface of a pneumatic tire associated with same embodiment as they would exist if unwrapped so as to lie in a single plane.

FIG. 5 is an enlarged view of region V in FIG. 4.

FIG. 6 is an enlarged view of a section taken along VI-VI in FIG. 5.

### DETAILED DESCRIPTION OF THE INVENTION

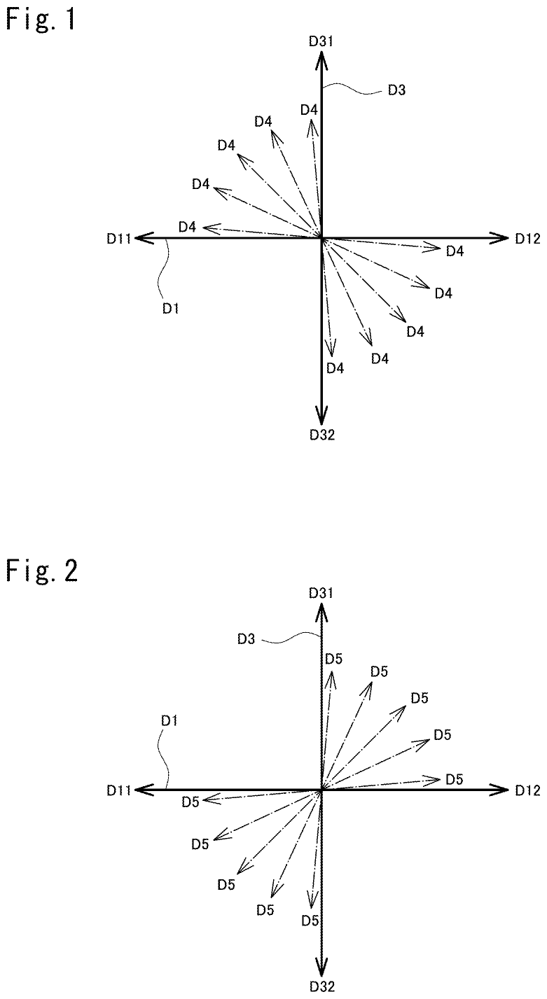

Below, an embodiment of a pneumatic tire is described with reference to FIG. 1 through FIG. 6. At the respective drawings, note that dimensional ratios at the drawings and actual dimensional ratios are not necessarily consistent, and note further that dimensional ratios are not necessarily consistent from drawing to drawing.

Note that the respective dimensions, positional relationships, relative magnitudes, and so forth that are indicated below should be understood to be as measured under normal conditions when the pneumatic tire (hereinafter also referred to as simply “tire”) 1 mounted on a normal rim 20 and inflated to normal internal pressure is under no load. A normal rim is that particular rim which is specified for use with a particular tire 1 in the context of the body of standards that contains the standard that applies to the tire 1 in question, this being referred to, for example, as a standard rim in the case of JATMA, or a measuring rim in the cases of TRA and ETRTO.

Furthermore, normal internal pressure is that air pressure which is specified for use with a particular tire 1 in the context of the body of standards that contains the standard that applies to the tire 1 in question, this being “maximum air pressure” in the case of JATMA, the maximum value listed at the table entitled “Tire Load Limits at Various Cold Inflation Pressures” in the case of IRA, or “inflation pressure” in the case of ETRTO.

At the respective drawings, first direction D1 is the tire axial direction D1 which is parallel to the tire rotational axis that is the center of rotation of tire 1, second direction D2 is the tire radial direction D2 which is the direction of the diameter of tire 1, and third direction D3 is the tire circumferential direction D3 which is circumferential with respect to the rotational axis of the tire.

Toward the interior in the tire axial direction D1 means nearer to tire equatorial plane S1, and toward the exterior in the tire axial direction D1 means farther away from tire equatorial plane 51. Furthermore, the side toward the interior in the tire radial direction D2 is the side which is nearer to the tire rotational axis, and the side toward the exterior in the tire radial direction D2 is the side which is farther away from the tire rotational axis.

First direction D11 of tire axial direction D1 is also referred to as first axial direction D11; second direction D12 of tire axial direction D1 is also referred to as second axial direction D12. Furthermore, first direction D31 of tire circumferential direction D3 is also referred to as first circumferential direction D31; second direction D32 of tire circumferential direction D3 is also referred to as second circumferential direction D32.

Tire equatorial plane S1 refers to a plane that is located centrally in the tire axial direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the line formed by the intersection of tire equatorial plane S1 and the outer surface (tread surface 2a, described below) in the tire radial direction D2 of tire 1.

Note, as shown in FIG. 1, that the direction D4 which is inclined so as to be increasingly directed toward first circumferential direction D31 as one proceeds toward first axial direction D11 (the direction which is inclined so as to be increasingly directed toward second circumferential direction D32 as one proceeds toward second axial direction D12) will be referred to as first inclined direction D4. Furthermore, as shown in FIG. 2, the direction D5 which is inclined so as to be increasingly directed toward second circumferential direction D32 as one proceeds toward first axial direction D11 (the direction which is inclined so as to be increasingly directed toward first circumferential direction D31 as one proceeds toward second axial direction D12) will be referred to as second inclined direction D5.

In addition, where it is said that the direction in which something is inclined with respect to tire circumferential direction D3 (tire axial direction D1) is the same as the direction in which something else is inclined with respect thereto, this means that the two are inclined in the same direction with respect thereto (e.g., when the two are mutually in first inclined directions D4, D4 or the two are mutually in second inclined directions D5, D5). That is, where it is said that the direction in which something is inclined with respect to tire circumferential direction D3 (tire axial direction D1) is the same as the direction in which something else is inclined with respect thereto, this should be understood to include the situation in which the two are inclined in the same direction D4, D4 (D5, D5) notwithstanding the fact that the angles of inclination thereof with respect to tire circumferential direction D3 (tire axial direction D1) may be different.

Furthermore, where it is said that the direction in which something is inclined with respect to tire circumferential direction D3 (tire axial direction D1) is opposite the direction in which something else is inclined with respect thereto, this means that the two are inclined in opposite directions (first inclined direction D4 and second inclined direction D5). That is, where it is said that the direction in which something is inclined with respect to tire circumferential direction D3 (tire axial direction D1) is opposite the direction in which something else is inclined with respect thereto, this should be understood to include the situation in which the two are inclined in opposite directions D4, D5 notwithstanding the fact that the angles of inclination thereof with respect to tire circumferential direction D3 (tire axial direction D1) may be the same.

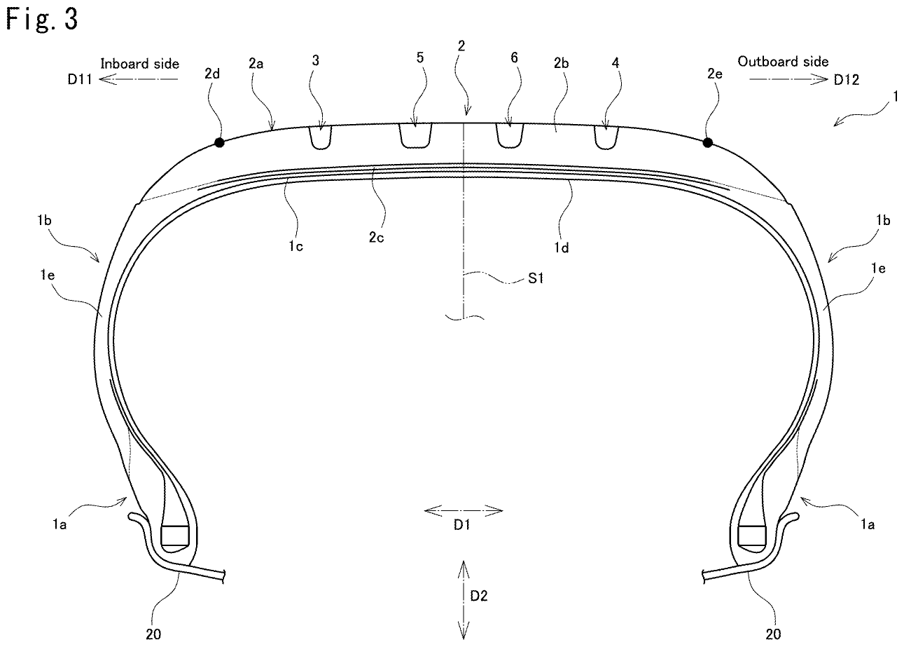

As shown in FIG. 3, tire 1 associated with the present embodiment comprises a pair of beads 1a at which bead cores are present; sidewalls 1b which extend outwardly in the tire radial direction D2 from the respective beads 1a; and tread 2, the exterior surface (tread surface 2a) in the tire radial direction D2 of which contacts the road surface and which is contiguous with the outer ends in the tire radial direction D2 of the pair of sidewalls 1b. In accordance with the present embodiment, tire 1 is a pneumatic tire 1, the interior of which is capable of being filled with air, and which is capable of being mounted on a rim 20.

Furthermore, tire 1 comprises carcass 1c which spans the pair of bead cores, and inner liner 1d which is arranged at a location toward the interior from carcass 1c and which has superior functionality in terms of its ability to impede passage of gas therethrough so as to permit air pressure to be maintained. Carcass 1c and inner liner 1d are arranged in parallel fashion with respect to the inner circumference of the tire over a portion thereof that encompasses beads 1a, sidewalls 1b, and tread 2.

Tire 1 has a structure that is asymmetric with respect to tire equatorial plane S1. In accordance with the present embodiment, tire 1 is a tire for which a vehicle mounting direction is indicated, which is to say that there is an indication of whether the left or the right side of the tire should be made to face the vehicle when tire 1 mounted on rim 20. Moreover, the tread pattern formed at tread surface 2a of tread 2 is shaped in asymmetric fashion with respect to tire equatorial plane S1.

For example, the orientation in which the tire is to be mounted on the vehicle may be indicated at sidewall 1b. More specifically, a constitution may be adopted in which sidewall 1b is provided with sidewall rubber 1e which is arranged toward the exterior in the tire axial direction D1 from carcass 1c so as to constitute the tire exterior surface, said sidewall rubber 1e having at the surface thereof an indicator region (not shown) that indicates an orientation in which the tire is to be mounted on the vehicle.

For example, one sidewall 1b, i.e., that which is to be arranged toward the interior when the tire is mounted on the vehicle (hereinafter also referred to as the “inboard side”), might be marked (e.g., with the word “INSIDE” or the like) so as to contain an indication to the effect that it is for the inboard side. Furthermore, for example, the other sidewall 1b, i.e., that which is to be arranged toward the exterior when the tire is mounted on the vehicle (hereinafter also referred to as the “outboard side”), might be marked (e.g., with the word “OUTSIDE” or the like) so as to contain an indication to the effect that it is for the outboard side. While there is no particular limitation with respect thereto, the side toward first axial direction D11 might, e.g., as is the case in the present embodiment, be taken to be the inboard side, and the side toward second axial direction D12 might be taken to be the outboard side.

Tread 2 is provided with tread rubber 2b having tread surface 2a which contacts the road surface, and belt 2c which is arranged between tread rubber 2b and carcass 1c. In addition, present at tread surface 2a is the contact patch that actually comes in contact with the road surface, the portions within said contact patch that are present at the outer ends in the tire axial direction D1 being referred to as contact patch ends 2d, 2e. Note that said contact patch refers to the tread surface 2a that comes in contact with the road surface when a normal load is applied to a tire 1 mounted on a normal rim 20 when the tire 1 is inflated to normal internal pressure and is placed in vertical orientation on a flat road surface.

Normal load is that load which is specified for use with a particular tire 1 in the context of the body of standards that contains the standard that applies to the tire 1 in question, this being “maximum load capacity” in the case of JATMA, the maximum value listed at the aforementioned table in the case of TRA, or “load capacity” in the case of ETRTO, which when tire 1 is to be used on a passenger vehicle is taken to be 85% of the load corresponding to an internal pressure of 180 kPa.

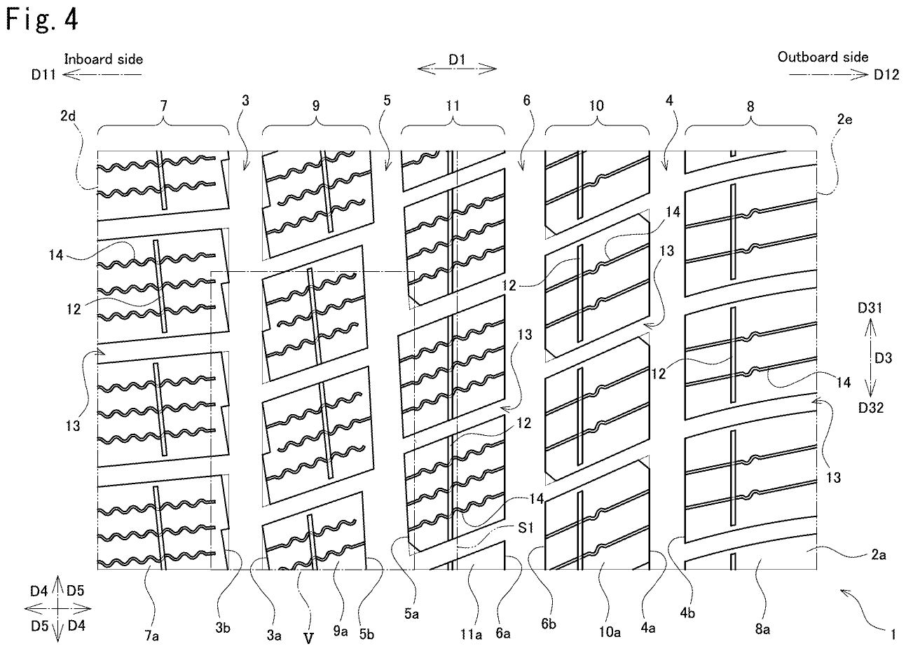

As shown in FIG. 3 and FIG. 4, tread rubber 2b comprises a plurality of main grooves 3, 4, 5, 6 that extend in the tire circumferential direction D3, and a plurality of lands 7, 8, 9, 10, 11 which are partitioned by the plurality of main grooves 3, 4, 5, 6 and a pair of contact patch ends 2d, 2e. While there is no particular limitation with respect thereto, the number of main grooves 3, 4, 5, 6 that are present might, e.g., as is the case in the present embodiment, be four, and the number of lands 7, 8, 9, 10, 11 that are present might be five.

Main grooves 3, 4, 5, 6 extend continuously in the tire circumferential direction D3. Main grooves 3, 4, 5, 6 might, for example, be provided with so-called tread wear indicators (not shown) which are portions at which depth of the groove is reduced so as to make it possible to ascertain the extent to which wear has occurred as a result of the exposure thereof that takes place in accompaniment to wear. Furthermore, main grooves 3, 4, 5, 6 might, for example, have groove widths that are each not less than 3% of the distance (dimension in the tire axial direction D1) between contact patch ends 2d, 2e. Furthermore, main grooves 3, 4, 5, 6 might, for example, have groove widths that are each not less than 5 mm.

The pair of main grooves 3, 4 arranged in outermost fashion in the tire axial direction D1 are referred to as shoulder main grooves 3, 4. Of the shoulder main grooves 3, 4, that main groove 3 which is arranged on the side in the first axial direction D11 (the inboard side) is referred to as first shoulder main groove 3, and that main groove 4 which is arranged on the side in the second axial direction D12 (the outboard side) is referred to as second shoulder main groove 4.

Furthermore, the main grooves 5, 6 arranged between the pair of shoulder main grooves 3, 4 are referred to as center main grooves 5, 6. Of the center main grooves 5, 6, that main groove 5 which is arranged on the side in the first axial direction D11 (the inboard side) is referred to as first center main groove 5, and that main groove 6 which is arranged on the side in the second axial direction D12 (the outboard side) is referred to as second center main groove 6.

Lands 7, 8 which are partitioned by a contact patch end 2d, 2e and a shoulder main groove 3, 4 are referred to as shoulder lands 7, 8; lands 9, 10, 11 which are partitioned by a pair of adjacent main grooves 3, 4, 5, 6 are referred to as middle lands 9, 10, 11. Note that middle lands 9, 10 which are partitioned by a center main groove 5, 6 and a shoulder main groove 3, 4 are also referred to as mediate lands 9, 10; middle land 11 which is partitioned by the pair of center main grooves 5, 6 is also referred to as center land 11.

Of the shoulder lands 7, 8, that land 7 which is arranged on the side in the first axial direction D11 (the inboard side) is referred to as first shoulder land 7, and that land 8 which is arranged on the side in the second axial direction D12 (the outboard side) is referred to as second shoulder land 8. Furthermore, of the mediate lands 9, 10, that land 9 which is arranged on the side in the first axial direction D11 (the inboard side) is referred to as first mediate land 9, and that land 10 which is arranged on the side in the second axial direction D12 (the outboard side) is referred to as second mediate land 10.

Lands 7, 8, 9, 10, 11 comprise a plurality of ancillary grooves 12, 13, 14. Of ancillary grooves 12, 13, 14, those ancillary grooves 12 which extend in the tire circumferential direction D3 are referred to as circumferential grooves 12; of ancillary grooves 12, 13, 14, those ancillary grooves 13, 14 which extend in the tire axial direction D1 are referred to as axial grooves 13, 14.

In addition, of axial grooves 13, 14, those axial grooves 13 for which the groove width at tread surface 2a is not less than 1.6 mm are referred to as slits 13, of axial grooves 13, 14, those axial grooves 14 for which the groove width at tread surface 2a is less than 1.6 mm are referred to as sipes 14. Note that the angles of inclination of circumferential grooves 12 with respect to the tire circumferential direction D3 are less than 45° , it being preferred, for example, that these be not greater than 30°. Furthermore, the angles of inclination of axial grooves 13, 14 with respect to tire axial direction D1 are not greater than 45° , it being preferred, for example, that these be not greater than 30°.

While there is no particular limitation with respect thereto, slits 13 may, e.g., as is the case in the present embodiment, all extend along the full length in the tire axial direction D1 of lands 7, 8, 9, 10, 11. That is, each of the two ends of each slit 13 may respectively be contiguous with a main groove 3, 4, 5, 6 or a contact patch end 2d, 2e. As a result, lands 7, 8, 9, 10, 11 comprise a plurality of blocks 7a, 8a, 9a, 10a, 11a which are partitioned by slits 13 so as to as to be arrayed in the tire circumferential direction D3.

While there is no particular limitation with respect thereto, note that the number of blocks 7a, 8a, 9a, 10a, 11a in the respective lands 7, 8, 9, 10, 11 may, e.g., as is the case in the present embodiment, be the same, and/or the number of slits 13 in the respective lands 7, 8, 9, 10, 11 may be the same. Furthermore, while there is no particular limitation with respect thereto, the groove widths of slits 13 may, e.g., as is the case in the present embodiment, be constant (here understood to mean not only the situation in which these are the same but to also include situations in which these are approximately the same such that there is a difference of ±5% therebetween) everywhere along the full lengths thereof.

The constitutions of main grooves 3, 4, 5, 6 will now be described with reference to FIG. 4.

As shown in FIG. 4, main grooves 3, 4, 5, 6 comprise straight main grooves 4, 6 and zigzag main grooves 3, 5. Note that straight main grooves 4, 6 are main grooves 4, 6 at which end edges 4a, 4b, 6a, 6b at tread surface 2a are respectively parallel to the tire circumferential direction D3; zigzag main grooves 3, 5 are main grooves 3, 5 at which end edges 3a, 3b, 5a, 5b at tread surface 2a are respectively inclined with respect to the tire circumferential direction D3.

In addition, at straight main grooves 4, 6, because water at the interior thereof is able to flow smoothly, improvement in performance with respect to water shedding is made possible. Moreover, at zigzag main grooves 3, 5, because it is possible to increase traction attributable to end edges 3a, 3b, 5a, 5b when on a snowy road surface, improvement in performance on snowy road surfaces is made possible.

Thus, because both straight main grooves 4, 6 and zigzag main grooves 3, 5 are comprised thereby, it is possible to achieve both performance with respect to water shedding and performance on snowy road surfaces. Accordingly, while there is no particular limitation with respect thereto, tire 1 associated with the present embodiment is capable of being used as an all-season tire (a tire suitable for dry road surfaces, wet road surfaces, and snowy road surfaces).

Furthermore, to improve the water shedding characteristics of the road surface, a prescribed road might, for example, be provided with rain grooves that extend in parallel fashion with respect to the direction in which a vehicle proceeds thereon. In addition, when a zigzag main groove 3, 5 is captured by a rain groove, because an end edge 3a, 3b, 5a, 5b of the zigzag main groove 3, 5 will be only partially entrained by the rain groove, the length of the portion which is entrained by the rain groove will be reduced.

As a result, because it is possible to suppress the increase in lateral forces that would otherwise occur at tire 1 when a zigzag main groove 3, 5 is captured in a rain groove, it will be possible to suppress the change in lateral forces acting on tire 1 that would otherwise exist before and after the zigzag main groove 3, 5 is captured by the rain groove. Accordingly, it will be possible to suppress occurrence of the phenomenon in which there is a tug on the steering wheel and the vehicle lurches (the groove wandering phenomenon).

When tire 1 is on an outside wheel when the vehicle is making a turn, it so happens that the contact patch length (the length in the tire circumferential direction D3 that is in contact with the ground) in regions toward the inboard side (the side toward first axial direction D11) will decrease, and the contact patch length in regions toward the outboard side (the side toward second axial direction D12) will increase. To address this, main grooves 3, 5 on the inboard side (the side toward first axial direction D11) are zigzag main grooves 3, 5, and main grooves 4, 6 on the outboard side (the side toward second axial direction D12) are straight main grooves 4, 6.

As a result, because the main grooves 3, 5 on the inboard side (the side toward first axial direction D11) at which contact patch length is short are zigzag main grooves 3, 5, it will be possible in regions toward the inboard side (the side toward first axial direction D11) to suppress occurrence of situations in which traction during turns on snowy road surfaces would otherwise be reduced. Moreover, because the main grooves 4, 6 on the outboard side (the side toward second axial direction D12) at which contact patch length is long are straight main grooves 4, 6, it will be possible in regions toward the outboard side (the side toward second axial direction D12) to suppress reduction in water shedding performance during turns that would otherwise occur. Accordingly, it is possible to achieve both performance with respect to water shedding and performance on snowy road surfaces during turns.

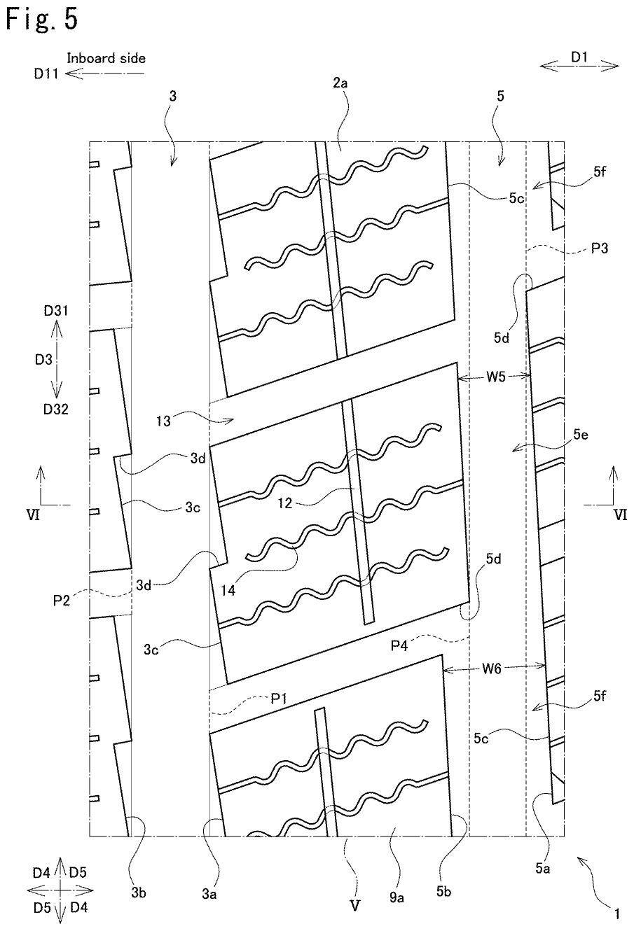

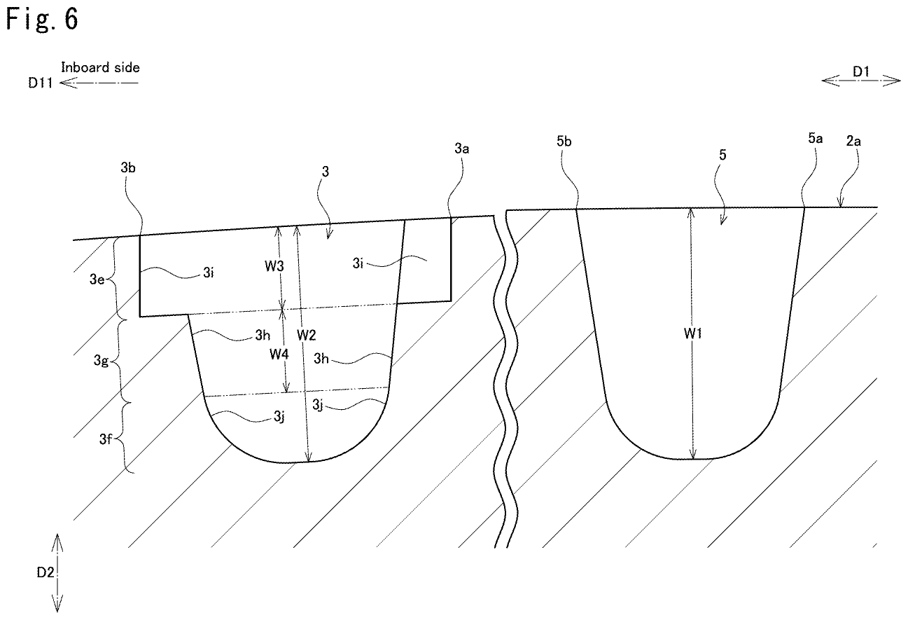

Next, the constitution with respect to zigzag main grooves 3, 5 (first shoulder main groove 3 and first center main groove 5) at which there is a tendency for flow of water at the interiors thereof to become turbulent will be described with reference to FIG. 5 and FIG. 6.

As shown in FIG. 5, end edges 3a, 3b, 5a, 5b at tread surface 2a of zigzag main grooves 3, 5 comprise a plurality of circumferential components 3c, 5c which extend in the tire circumferential direction D3, and a plurality of axial components 3d, 5d which extend in the tire axial direction D1. Note that the angles of inclination of circumferential components 3c, 5c with respect to the tire circumferential direction D3 are less than 45° , and the angles of inclination of axial components 3d, 5d with respect to the tire axial direction D1 are not greater than 45°.

In addition, the plurality of circumferential components 3c, 5c all extend so as to be inclined in the first inclined direction D4. As a result, because all of the plurality of circumferential components 3c, 5c are inclined in the same direction D4 with respect to the tire circumferential direction D3, it is possible to suppress occurrence of turbulence in the flow of water within zigzag main grooves 3, 5.

Accordingly, because it will be possible to suppress occurrence of a situation in which water would otherwise accumulate within zigzag main grooves 3, 5, it will be possible to suppress reduction in water shedding performance attributable to zigzag main grooves 3, 5 that would otherwise occur. Moreover, while there is no particular limitation with respect thereto, circumferential components 3c of first shoulder main groove 3 and circumferential components 5c of first center main groove 5 may, e.g., as is the case in the present embodiment, extend so as to be inclined in the same first inclined direction D4.

Furthermore, the plurality of axial components 3d, 5d may, e.g., as is the case in the present embodiment, all extend so as to be inclined in the same direction (more specifically, the second inclined direction) D5 with respect to the tire circumferential direction D3. Furthermore, axial components 3d, 5d and circumferential components 3c, 5c may, e.g., as is the case in the present embodiment, extend in opposite directions D5, D4 with respect to the tire circumferential direction D3. Furthermore, axial components 3d of first shoulder main groove 3 and axial components 5d of first center main groove 5 may, e.g., as is the case in the present embodiment, extend so as to be inclined in the same second inclined direction D5.

Furthermore, end edges 3a, 3b, 5a, 5b at tread surface 2a comprise inner end edges 3a, 5a which are arranged toward the interior in the tire axial direction D1, and outer end edges 3b, 5b which are arranged toward the exterior in the tire axial direction D1. At FIG. 5, outwardmost locations P1, P3 in the tire axial direction D1 of inner end edges 3a, 5a, and inwardmost locations P2, P4 in the tire axial direction D1 of outer end edges 3b, 5b, are respectively shown in broken line.

In addition, outwardmost locations P1, P3 of inner end edges 3a, 5a are arranged toward the interior in the tire axial direction D1 from inwardmost locations P2, P4 of outer end edges 3b, 5b. As a result, because straight spaces which extend so as to be parallel with respect to the tire circumferential direction D3 are formed within zigzag main grooves 3, 5, water within zigzag main grooves 3, 5 will flow smoothly along the straight spaces. Accordingly, because it will be possible to suppress occurrence of a situation in which water would otherwise accumulate within zigzag main grooves 3, 5, it will be possible to suppress reduction in water shedding performance attributable to zigzag main grooves 3, 5 that would otherwise occur.

When the vehicle is going straight ahead, because contact patch length in regions toward the interior in the tire axial direction D1 increases, it so happens that the contact patch length at first center main groove 5 will be greater than contact patch length at first shoulder main groove 3. As a result, because water tends to accumulate within first center main groove 5, this tends to cause reduction in water shedding performance.

Length(s) (e.g., average length) of circumferential components 5c at first center main groove 5 are therefore made to be greater than length(s) (e.g., average length) of circumferential components 3c at first shoulder main groove 3. As a result, because it is possible to suppress occurrence of a situation in which flow of water within first center main groove 5 becomes turbulent, it is possible to suppress accumulation of water within first center main groove 5. Accordingly, it is possible to suppress reduction in water shedding performance attributable to first center main groove 5.

Moreover, as shown in FIG. 5 and FIG. 6, depth W1 of first center main groove 5 is greater than depth W2 of first shoulder main groove 3. As a result, because it is possible to increase the size of the intragroove space (i.e., the water flow channel) at first center main groove 5, it will be possible to suppress accumulation of water within first center main groove 5. Accordingly, it will be possible to suppress reduction in water shedding performance attributable to first center main groove 5.

While not shown in the drawings, note that, in accordance with the present embodiment, depth of second center main groove 6 is greater than depth of second shoulder main groove 4. More specifically, respective depths of respective center main grooves 5, 6 are greater than respective depths of respective shoulder main grooves 3, 4. As a result, because it is possible to increase the sizes of the intragroove spaces at respective center main grooves 5, 6, it will be possible to improve the water shedding performance of tire 1.

On the other hand, first shoulder main groove 3 for which length(s) of circumferential components 3c are small comprises groove outer portion 3e which includes outer ends in the tire radial direction D2; groove base portion 3f which includes the bottom; and groove inner portion 3g which is arranged between groove base portion 3f and groove outer portion 3e in the tire radial direction D2. At FIG. 6, note that boundaries between respective portions 3e, 3f, 3g are shown in double-dash chain line.

For example, in accordance with the present embodiment, as viewed in a tire meridional section, boundaries between groove base portion 3f and groove inner portion 3g may be the boundaries of linear wall faces 3h, 3j with curved regions. More specifically, the constitution may be such that, as viewed in a tire meridional section, wall faces 3h, 3h of groove inner portion 3g are linear, and such that at least those portions of wall faces 3j, 3j of groove base portion 3f which correspond to the outer portions thereof in the tire radial direction D2 are curved.

Groove inner portion 3g comprise a pair of inner wall faces 3h, 3h that are mutually separated in the tire axial direction D1. In addition, the pair of inner wall faces 3h, 3h are respectively parallel to the tire circumferential direction D3. As a result, because it will be possible for water at the interior of first shoulder main groove 3 to flow smoothly at groove inner portion 3g, it will be possible to suppress reduction in water shedding performance attributable to first shoulder main groove 3.

Moreover, groove outer portion 3e comprises a pair of outer wall faces 3i, 3i that are mutually separated in the tire axial direction D1. In addition, the pair of outer wall faces 3i, 3i are respectively inclined with respect to the tire circumferential direction D3. While there is no particular limitation with respect thereto, it is preferred, for example, that depth W3 of groove outer portion 3e be not greater than 50% of depth W2 of first shoulder main groove 3. Furthermore, while there is no particular limitation with respect thereto, it is preferred, for example, that depth W3 of groove outer portion 3e be greater than depth W4 of groove inner portion 3g.

It so happens that presence of straight spaces at zigzag main grooves 3, 5 tends to cause increase in the production of noise due to the straight spaces. First center main groove 5 therefore comprises small-width portion(s) 5e for which width at tread surface 2a is first width W5, and large-width portion(s) 5f for which width at tread surface 2a is second width W6 which is greater than first width W5.

As a result, because cross-sectional area of the intragroove space of first center main groove 5 is made to vary in the tire circumferential direction D3, this makes it possible to suppress production of noise due to straight spaces. Moreover, when the vehicle is going straight ahead, to address the fact that contact patch length in regions toward the interior in the tire axial direction D1 increases, because first center main groove 5 which possesses small-width portion 5e and large-width portion 5f is that main groove 5 which, of zigzag main grooves 3, 5, is arranged toward the interior in the tire axial direction D1, it is possible to effectively suppress production of noise.

As described above, as in the present embodiment, it is preferred that the pneumatic tire 1 includes a tread 2 having a tread surface 2a; wherein

the tread 2 comprises a plurality of main grooves 3, 4, 5, 6 that extend in a tire circumferential direction D3;

the plurality of main grooves 3, 4, 5, 6 include at least one straight main groove 4, 6 for which end edges 4a, 4b 6a, 6b at the tread surface 2a are respectively parallel to the tire circumferential direction D3, and at least one zigzag main groove 3, 5 for which end edges 3a, 3b, 5a, 5b at the tread surface 2a are respectively inclined with respect to the tire circumferential direction D3;

the end edges 3a, 3b, 5a, 5b at the tread surface 2a of the at least one zigzag main groove 3, 5 include an inner end edge 3a, 5a which is arranged toward an interior in a tire axial direction D1, and an outer end edge 3b, 5b which is arranged toward an exterior in the tire axial direction D1; and

an outwardmost location P1, P3 in the tire axial direction D1 of the inner end edge 3a, 5a is arranged toward the interior in the tire axial direction from an inwardmost location P2, P4 in the tire axial direction D1 of the outer end edge 3b, 5b.

In accordance with such constitution, because end edges 3a, 3b, 5a, 5b of zigzag main grooves 3, 5 at tread surface 2a are respectively inclined with respect to the tire circumferential direction D3, it is possible to increase traction with respect to snowy road surfaces attributable to end edges 3a, 3b, 5a, 5b. As a result, it will be possible to improve performance on snowy road surfaces.

Further, as in the present embodiment, it is preferred that the pneumatic tire 1 includes a configuration in which:

the end edges 3a, 3b, 5a, 5b at the tread surface 2a of the at least one zigzag main groove 3, 5 include a plurality of circumferential components 3c, 5c which extend in the tire circumferential direction D3;

the at least one zigzag main groove 3, 5 includes a first zigzag main groove 5 (first center main groove 5 in the present embodiment), and a second zigzag main groove 3 (first shoulder main groove 3 in the present embodiment) which is arranged toward the exterior in the tire axial direction D1 from the first zigzag main groove 5; and

average length of the circumferential components 5c of the first zigzag main groove 5 are greater than average length of the circumferential components 3c of the second zigzag main groove 3.

In accordance with such constitution, to address the fact that contact patch length in the tire circumferential direction D3 at first zigzag main groove 5 is greater than contact patch length in the tire circumferential direction D3 at second zigzag main groove 3 when the vehicle is going straight ahead, length(s) of circumferential components 5c at first zigzag main groove 5 are made to be greater than length(s) of circumferential components 3c at second zigzag main groove 3. As a result, because it is possible to suppress occurrence of a situation in which flow of water becomes turbulent within first zigzag main groove 5 at which contact patch length is large, it is possible to suppress accumulation of water within first zigzag main groove 5.

Further, as in the present embodiment, it is preferred that the pneumatic tire 1 includes a configuration in which:

the at least one zigzag main groove 3 comprises a groove outer portion 3e which includes the end edges 3a, 3b at the tread surface 2a of the at least one zigzag main groove 3, a groove base portion 3f which includes a bottom, and a groove inner portion 3g which is arranged between the groove base portion 3f and the groove outer portion 3e in the tire radial direction D2;

the groove inner portion 3g comprises a pair of inner wall faces 3h, 3h that are separated in the tire axial direction D1; and

the pair of inner wall faces 3h, 3h are respectively parallel to the tire circumferential direction D3.

In accordance with such constitution, groove inner portion 3g is arranged between groove base portion 3f and groove outer portion 3e in the tire radial direction D2, and the pair of inner wall faces 3h, 3h at groove inner portion 3g are respectively parallel to the tire circumferential direction D3. As a result, it is possible for water at the interior of zigzag main groove 3 to flow smoothly at groove inner portion 3g.

Further, as in the present embodiment, it is preferred that the pneumatic tire 1 includes a configuration in which:

the at least one zigzag main groove 5 comprises a small-width portion 5e for which width at the tread surface 2a is a first width W5, and a large-width portion 5f for which width at the tread surface 2a is a second width W6 which is greater than the first width W5.

In accordance with such constitution, whereas straight spaces are formed which extend so as to be parallel with respect to the tire circumferential direction D3, first zigzag main groove 5 comprises small-width portion(s) 5e and large-width portion(s) 5f. As a result, it is possible to cause cross-sectional area of the intragroove space at zigzag main groove 5 to vary in the tire circumferential direction D3.

Further, as in the present embodiment, it is preferred that the pneumatic tire 1 includes a configuration in which:

the end edges 3a, 3b, 5a, 5b at the tread surface 2a of the at least one zigzag main groove 3, 5 include a plurality of circumferential components 3c, 5c which extend in the tire circumferential direction D3; and

the plurality of circumferential components 3c, 5c are all inclined in a same direction D4 with respect to the tire circumferential direction D3.

In accordance with such constitution, because all of the plurality of circumferential components 3c, 5c are inclined in the same direction D4 with respect to the tire circumferential direction D3, it is possible to suppress occurrence of turbulence in the flow of water within zigzag main grooves 3, 5. As a result, it is possible to suppress accumulation of water within zigzag main grooves 3, 5.

Further, as in the present embodiment, it is preferred that the pneumatic tire 1 includes a configuration in which:

the plurality of main grooves 3, 4, 5, 6 include a pair of shoulder main grooves 3, 4 arranged outwardmostly in the tire axial direction D1, and at least one center main groove 5, 6 arranged between the pair of shoulder main grooves 3, 4; and

depth W1 of the at least one center main groove 5, 6 is greater than respective depths W2 of the pair of shoulder main grooves 3, 4.

In accordance with such constitution, to address the fact that contact patch length in the tire circumferential direction D3 at center main grooves 5, 6 is greater than contact patch length in the tire circumferential direction D3 at shoulder main grooves 3, 4 when the vehicle is going straight ahead, depths W1 of center main grooves 5, 6 are made to be greater than depths W2 of shoulder main grooves 3, 4. Because this increase the sizes of the intragroove spaces at center main grooves 5, 6, it will make it possible to suppress accumulation of water within center main grooves 5, 6.

Further, as in the present embodiment, it is preferred that

the pneumatic tire 1 further includes an indicator region that indicates an orientation in which the tire is to be mounted on a vehicle; wherein

the at least one straight main groove 4, 6 is arranged at an outboard side relative to a tire equatorial plane S1; and

the at least one zigzag main groove 3, 5 is arranged at an inboard side relative to the tire equatorial plane S1.

In accordance with such constitution, to address the fact that contact patch length in regions toward the outboard side will increase when tire 1 is on an outside wheel when the vehicle is making a turn, straight main grooves 4, 6 are arranged toward the outboard side. This makes it possible to suppress reduction in water shedding performance during turns that would otherwise occur in regions toward the outboard side.

Further, to address the fact that contact patch length in regions toward the inboard side will decrease when tire 1 is on an outside wheel when the vehicle is making a turn, zigzag main grooves 3, 5 are arranged toward the inboard side. This makes it possible to suppress to reduce traction during turns on snowy road surfaces that would otherwise occur in regions toward the inboard side.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that it comprises two zigzag main grooves 3, 5, and it comprises two straight main grooves 4, 6. However, pneumatic tire 1 is not limited to such constitution. There is no particular limitation with respect to the number of zigzag main groove(s) 3, 5 and straight main groove(s) 4, 6, it being sufficient that at least one zigzag main groove 3, 5 and straight main groove 4, 6 be respectively comprised thereby.

(2) Furthermore, the constitution of pneumatic tire 1 associated with the foregoing embodiment is such that length(s) of circumferential components 5c at first zigzag main groove 5 which is arranged toward the interior in the tire axial direction D1 are greater than length(s) of circumferential components 3c at second zigzag main groove 3 which is arranged toward the exterior in the tire axial direction D1. However, pneumatic tire 1 is not limited to such constitution.

For example, it is also possible to adopt a constitution in which length(s) of circumferential components 5c at first zigzag main groove 5 are less than length(s) of circumferential components 3c at second zigzag main groove 3. Furthermore, it is also possible, for example, to adopt a constitution in which length(s) of circumferential components 5c at first zigzag main groove 5 are the same as length(s) of circumferential components 3c at second zigzag main groove 3.

(3) Furthermore, the constitution of pneumatic tire 1 associated with the foregoing embodiment is such that first shoulder main groove 3 which is a zigzag main groove 3 comprises groove outer portion 3e, groove inner portion 3g, and groove base portion 3f. However, pneumatic tire 1 is not limited to such constitution.

For example, it is also possible to adopt a constitution in which first shoulder main groove 3 comprises groove outer portion 3e which includes outer ends in the tire radial direction D2, and groove base portion 3f which is contiguous with groove outer portion 3e and includes the bottom, like first center main groove 5 which is a zigzag main groove 5. Furthermore, for example, it is also possible to adopt a constitution in which first center main groove 5 comprises a groove outer portion, a groove inner portion, and a groove base portion, like first shoulder main groove 3.

(4) Furthermore, the constitution of pneumatic tire 1 associated with the foregoing embodiment is such that first center main groove 5 which is a zigzag main groove 5 comprises small-width portion 5e and large-width portion 5f. However, pneumatic tire 1 is not limited to such constitution.

For example, it is also possible to adopt a constitution in which width at tread surface 2a of first center main groove 5 is constant (here understood to mean not only the situation in which these are the same but to also include situations in which these are approximately the same such that there is a difference of ±5% therebetween) , like first shoulder main groove 3 which is a zigzag main groove 3. Furthermore, for example, it is also possible to adopt a constitution in which first shoulder main groove 3 comprises small-width portion(s) and large-width portion(s) , like first center main groove 5.

(5) Furthermore, the constitution of pneumatic tire 1 associated with the foregoing embodiment is such that the plurality of circumferential components 3c, 5c are all inclined in the same direction D4 with respect to the tire circumferential direction D3. However, pneumatic tire 1 is not limited to such constitution. For example, it is also possible to adopt a constitution in which some of the plurality of circumferential components 3c, 5c extend in first inclined direction D4, and some of the plurality of circumferential components 3c, 5c extend in second inclined direction D5.

(6) Furthermore, the constitution of pneumatic tire 1 associated with the foregoing embodiment is such that depth(s) W1 of center main grooves 5, 6 are greater than depth(s) W2 of shoulder main grooves 3, 4. However, pneumatic tire 1 is not limited to such constitution. For example, it is also possible to adopt a constitution in which depths W1 of center main grooves 5, 6 are the same as depths W2 of shoulder main grooves 3, 4. Furthermore, for example, it is also possible to adopt a constitution in which depth(s) W1 of center main grooves 5, 6 are less than depth(s) W2 of shoulder main grooves 3, 4.

(7) Furthermore, the constitution of pneumatic tire 1 associated with the foregoing embodiment is such that this is a tire for which a vehicle mounting direction is indicated. However, pneumatic tire 1 is not limited to such constitution. For example, it is also possible to adopt a constitution in which pneumatic tire 1 is a tire for which a vehicle mounting direction is not indicated. More specifically, the tread pattern may be a tread pattern that exhibits point symmetry about an arbitrary point on the tire equator, or may be a tread pattern that exhibits line symmetry about the tire equator.

1. A pneumatic tire comprising a tread having a tread surface; wherein
the tread comprises a plurality of main grooves that extend in a tire circumferential direction;
the plurality of main grooves include at least one straight main groove for which end edges at the tread surface are respectively parallel to the tire circumferential direction, and at least one zigzag main groove for which end edges at the tread surface are respectively inclined with respect to the tire circumferential direction;
the end edges at the tread surface of the at least one zigzag main groove include an inner end edge which is arranged toward an interior in a tire axial direction, and an outer end edge which is arranged toward an exterior in the tire axial direction; and
an outwardmost location in the tire axial direction of the inner end edge is arranged toward the interior in the tire axial direction from an inwardmost location in the tire axial direction of the outer end edge.

2. The pneumatic tire according to claim 1 wherein
the end edges at the tread surface of the at least one zigzag main groove include a plurality of circumferential components which extend in the tire circumferential direction;
the at least one zigzag main groove includes a first zigzag main groove, and a second zigzag main groove which is arranged toward the exterior in the tire axial direction from the first zigzag main groove; and
average length of the circumferential components of the first zigzag main groove are greater than average length of the circumferential components of the second zigzag main groove.

3. The pneumatic tire according to claim 2 wherein a direction in which the circumferential components of the first zigzag main groove are inclined with respect to the tire circumferential direction is same as a direction in which the circumferential components of the second zigzag main groove are inclined with respect to the tire circumferential direction.

4. The pneumatic tire according to claim 3 wherein
the end edges at the tread surface of the first and second zigzag main grooves respectively include a plurality of axial components which extend in the tire axial direction; and
a direction in which the axial components of the first zigzag main groove are inclined with respect to the tire axial direction is same as a direction in which the axial components of the second zigzag main groove are inclined with respect to the tire axial direction.

5. The pneumatic tire according to claim 1 wherein
the at least one zigzag main groove comprises a groove outer portion which includes the end edges at the tread surface of the at least one zigzag main groove, a groove base portion which includes a bottom, and a groove inner portion which is arranged between the groove base portion and the groove outer portion in the tire radial direction;
the groove inner portion comprises a pair of inner wall faces that are separated in the tire axial direction; and
the pair of inner wall faces are respectively parallel to the tire circumferential direction.

6. The pneumatic tire according to claim 1 wherein the at least one zigzag main groove comprises a small-width portion for which width at the tread surface is a first width, and a large-width portion for which width at the tread surface is a second width which is greater than the first width.

7. The pneumatic tire according to claim 1 wherein
the end edges at the tread surface of the at least one zigzag main groove include a plurality of circumferential components which extend in the tire circumferential direction; and
the plurality of circumferential components are all inclined in a same direction with respect to the tire circumferential direction.

8. The pneumatic tire according to claim 7 wherein
the end edges at the tread surface of the at least one zigzag main groove include a plurality of axial components which extend in the tire axial direction; and
the plurality of axial components are all inclined in a same direction with respect to the tire axial direction.

9. The pneumatic tire according to claim 1 wherein
the plurality of main grooves include a pair of shoulder main grooves arranged outwardmostly in the tire axial direction, and at least one center main groove arranged between the pair of shoulder main grooves; and
depth of the at least one center main groove is greater than respective depths of the pair of shoulder main grooves.

10. The pneumatic tire according to claim 1 further comprising an indicator region that indicates an orientation in which the tire is to be mounted on a vehicle; wherein
the at least one straight main groove is arranged at an outboard side relative to a tire equatorial plane; and
the at least one zigzag main groove is arranged at an inboard side relative to the tire equatorial plane.

11. A pneumatic tire comprising a tread having a tread surface; wherein
the tread comprises a plurality of main grooves that extend in a tire circumferential direction;
the plurality of main grooves include first and second shoulder main grooves arranged outwardmostly in a tire axial direction;
the first shoulder main groove is a zigzag main groove, end edges of which at the tread surface are respectively inclined with respect to the tire circumferential direction;
the second shoulder main groove is a straight main groove, end edges of which at the tread surface are respectively parallel to the tire circumferential direction;
the end edges at the tread surface of the first shoulder main groove include a first inner end edge which is arranged toward an interior in the tire axial direction, and a first outer end edge which is arranged toward an exterior in the tire axial direction; and
an outwardmost location in the tire axial direction of the first inner end edge is arranged toward the interior in the tire axial direction from an inwardmost location in the tire axial direction of the first outer end edge.

12. The pneumatic tire according to claim 11 wherein the plurality of main grooves further include a first center main groove which is adjacent to the first shoulder main groove;
end edges at the tread surface of the first center main groove include a second inner end edge which is arranged toward the interior in the tire axial direction, and a second outer end edge which is arranged toward the exterior in the tire axial direction; and
an outwardmost location in the tire axial direction of the second inner end edge is arranged toward the interior in the tire axial direction from an inwardmost location in the tire axial direction of the second outer end edge.

13. The pneumatic tire according to claim 12 wherein
the plurality of main grooves further include a second center main groove which is adjacent to the second shoulder main groove; and
the second center main groove is a straight main groove, end edges of which at the tread surface are respectively parallel to the tire circumferential direction.

14. The pneumatic tire according to claim 12 wherein
the end edges at the tread surface of the first shoulder main groove include a plurality of circumferential components which extend in the tire circumferential direction;
the end edges at the tread surface of the first center main groove include a plurality of circumferential components which extend in the tire circumferential direction; and
average length of the circumferential components of the first center main groove are greater than average length of the circumferential components of the first shoulder main groove.

15. The pneumatic tire according to claim 12 wherein a direction in which the circumferential components of the first center main groove are inclined with respect to the tire circumferential direction is same as a direction in which the circumferential components of the first shoulder main groove are inclined with respect to the tire circumferential direction.

16. The pneumatic tire according to claim 15 wherein
the end edges at the tread surface of the first shoulder main groove and the first center main groove respectively include a plurality of axial components which extend in the tire axial direction; and
a direction in which the axial components of the first center main groove are inclined with respect to the tire axial direction is same as a direction in which the axial components of the first shoulder main groove are inclined with respect to the tire axial direction.

17. The pneumatic tire according to claim 11 wherein
the first shoulder main groove comprises a groove outer portion which includes the first inner end edge and the first outer end edge, a groove base portion which includes a bottom, and a groove inner portion which is arranged between the groove base portion and the groove outer portion in the tire radial direction;
the groove inner portion comprises a pair of inner wall faces that are separated in the tire axial direction; and
the pair of inner wall faces are respectively parallel to the tire circumferential direction.

18. The pneumatic tire according to claim 12 wherein the first center main groove comprises a small-width portion for which width at the tread surface is a first width, and a large-width portion for which width at the tread surface is a second width which is greater than the first width.

19. The pneumatic tire according to claim 12 wherein depth of the first center main groove is greater than depth of the first shoulder main groove.

20. The pneumatic tire according to claim 11 further comprising an indicator region that indicates an orientation in which the tire is to be mounted on a vehicle; wherein
the first shoulder main groove is arranged at an inboard side relative to a tire equatorial plane; and
the second shoulder main groove is arranged at an outboard side relative to the tire equatorial plane.
